(19) United States
(12) Patent Application Publication
(10) Pub. No.: US 2025/0126140 A1
(43) Pub. Date: Apr. 17, 2025

(54) MALICIOUS ENUMERATION ATTACK DETECTION

(71) Applicant: Sophos Limited, Abingdon (GB)

(72) Inventor: Tristan Parker Mayfield, Bluffdale, UT (US)

(21) Appl. No.: 18/485,564

(22) Filed: Oct. 12, 2023

(51) Int. Cl. H04L 9/40

(52) U.S. Cl. CPC H04L 63/1425; H04L 63/1416

(57) ABSTRACT

A computer system implemented method includes receiving flow data associated with web traffic from one or more requesters for a website, analyzing the flow data associated with the web traffic for the website, determining whether the flow data associated with the web traffic for the website indicates a likelihood of a malicious enumeration attack, and alerting an administrator of the website of the likelihood of the malicious enumeration attack. Further disclosed is computer systems and computer program products configured to perform the disclosed methods.

### FIELD

The present disclosure relates generally to detection of malicious enumeration attacks. More specifically, the present disclosure relates to a flow-based analytics approach for detecting malicious enumeration attacks on a network.

### BACKGROUND

Network Detection Response (NDR) solutions often generate network flow data including a high-level summary of communications over locations on a network. This network flow data can be used for a wide variety of purposes, such as threat detection. Rules engines and many network summaries may be available to end users with this network flow data.

Both websites facing external and internal traffic can be subject to information gathering attacks, such as malicious enumeration attacks. During a malicious enumeration attack, a malicious actor will attempt to see if there are webpages served by accident or unintentionally, or if there are pages that expose information or code that yields potential avenues for further exploitation. Some web servers have built-in logging features to either detect malicious enumeration attempts, or at least to log all requests. Relying on these or a custom server requires a certain level of trust. If monitoring network traffic, as with an NDR solution, web requests can yield too much data for a human to reasonably sift through to find malicious or inappropriate behaviors with typical flow-based analytics.

As such, a flow-based approach for automatically detecting malicious enumeration attacks on a network, website, webserver, or the like, would be well received in the art.

### SUMMARY

According to embodiments of the present invention, a method, and associated computer system and computer program product for detecting malicious enumeration attacks is provided. According to the method, one or more processors of a network detection and response computer system receive flow data associated with web traffic from one or more requesters for a website and analyze the flow data associated with the web traffic for the website. The one or more processors of the network detection and response computer system determine whether the flow data associated with the web traffic for the website indicates a likelihood of a malicious enumeration attack and alert an administrator of the website of the likelihood of the malicious enumeration attack.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 depicts a block diagram of an environment for threat management, according to an example embodiment.

FIG. 2 depicts an architectural representation of a network detection and response computer system, according to an example embodiment.

FIG. 3 depicts a diagram of modules included in computer code contained in the computer systems of FIGS. 1 and 2, according to an example embodiment.

FIG. 4 depicts a method for detecting malicious enumeration attacks, according to an example embodiment.

FIG. 5 depicts a method for analyzing flow data associated with web traffic for a website, according to an example embodiment.

FIG. 6 depicts a method for calculating a security score, according to an example embodiment.

FIG. 7 depicts a diagram of an example computing device, according to an example embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

Embodiments herein are directed to methods and computer systems configured to detect and respond to malicious enumeration attacks based on an analysis of flow related data. In particular, embodiments relate to NDR solutions. Embodiments described herein detect attempts to scan a website by using flow-based analytics to alert a user if there is a high chance of a malicious enumeration occurring.

The present methods and systems use this flow related data, rather than deep packet inspection. As defined herein, “flow related data” means data resulting from a flow-based analysis which is processed by a router, such as IP addresses, MAC addresses, traffic volume (number of bytes), host names and web pages, and possible packet headers or metadata. “Flow related data” is specifically not a packet or deep packet analysis on the specific data within a packet. Therefore, “flow related data” does not refer to a review of private data or encrypted data. Unlike processing flow related data, packet analysis typically includes processing certificates, and decryptions, in order to see inside a packet completely.

Using flow related data, the present embodiments determine whether web traffic meets the criteria that allows for an administrator to make a determination with a high degree of certainty or confidence that there is a malicious enumeration attack such as a website scan or the like. This confidence mechanism further allows an end user to dismiss an issue, or focus on an issue, depending on a degree of confidence established that a malicious enumeration attack such as a website scan has occurred.

For the purposes of embodiments described herein, it is recognized that both websites facing external and internal traffic can be subject to information gathering attacks, such as malicious enumeration attacks. An enumeration attack may attempt to see if there are webpages served by accident or unintentionally, or if there are pages that expose information or code that can yield potential avenues of exploitation. The present embodiments seek to be an automatic third-party observer of these sorts of inappropriate behaviors or malicious attacks, and bases determinations based on an objective and reliable analysis of these threats. Embodiments herein seek to use reliable and objective processes in an NDR solution which would otherwise require a human to sift through a large amount of data to make subjective determinations.

Present embodiments provide a technological advancement over the art of web traffic analysis by automating the determination of malicious enumeration attacks without human intervention and/or subjective analysis. Present embodiments described herein can then use these determinations in order to provide summaries or alerts available to end users or administrators that there is a high chance of a malicious enumeration occurring, which was previously not possible without difficult and subjective analysis by the end users or administrators. Moreover, the technological advancements described herein advantageously rely on flow related data to make these determinations, rather than requiring deep packet inspection, thereby avoiding analysis of private or encrypted data. Instead, advantageously, embodiments described herein rely on a review of metadata and information available to routers or other networking devices, such as IP addresses, MAC addresses, the number of bytes, host names, web pages, packet headers and the like.

Embodiments described herein may be deployed by a central threat management facility or system which can facilitate in monitoring and assisting a customer of these potential enumeration threats when the systems or methods determine a threat is likely via automated flow data analysis. Present systems may operate at regular intervals and communicate threat alerts, updates, or responses, as appropriate and necessary.

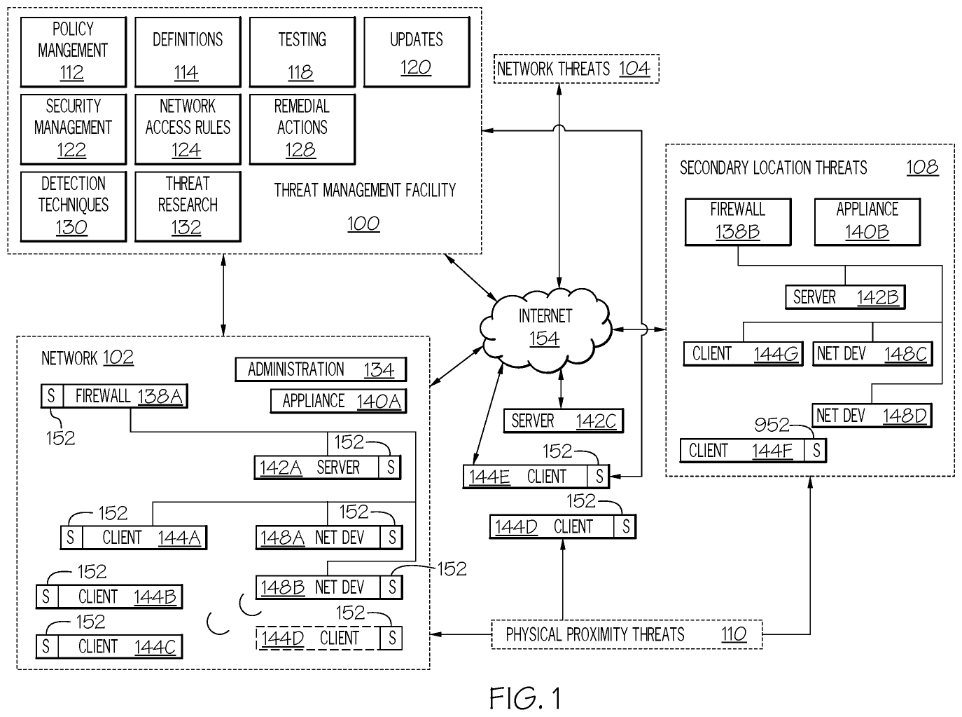

FIG. 1 illustrates an environment for threat management, according to an example embodiment. Specifically, FIG. 1 depicts a block diagram of a threat management facility 100 providing protection to one or more enterprises, networks, locations, users, businesses, etc. against a variety of threats-a context in which the techniques described herein may usefully be deployed. The threat management facility 100 may represent any the threat management system, such as the threat management systems described herein below.

The threat management facility 100 may be used to protect devices and assets (e.g., IoT devices or other devices) from computer-generated and human-generated threats. For example, a corporation, school, web site, homeowner, network administrator, or other entity may institute and enforce one or more policies that control or prevents certain network users (e.g., employees, residents, users, guests, etc.) from accessing certain types of applications, devices, resources generally or in a particular manner. Policies may be created, deployed and managed, for example, through the threat management facility 100, which may update and monitor network devices, users, and assets accordingly.

The threat of enumeration attacks, malware or other compromises may be present at various points within a network 102 such as laptops, desktops, servers, gateways, communication ports, handheld or mobile devices, IoT devices, firewalls. In addition to controlling or stopping malicious code, a threat management facility 100 may provide policy management to control devices, applications, or users that might otherwise undermine productivity and network performance within the network 102.

The threat management facility 100 may provide protection to network 102 from computer-based malware, including viruses, spyware, adware, Trojans, intrusion, spam, policy abuse, advanced persistent threats, uncontrolled access, and the like. In general, the network 102 may be any networked computer-based infrastructure or the like managed by a threat management facility 100, such as an organization, association, institution, or the like, or a cloud-based facility that is available for subscription by individuals. For example, the network 102 may be a corporate, commercial, educational, governmental, or other network 102, and may include multiple networks, computing resources, and other facilities, may be distributed among more than one geographical location, and may include administration 134, a firewall 138A, an appliance 140A, a server 142A, network devices 148A-B, clients 144A-D, such as IoT devices or other devices. It will be understood that any reference herein to a client or client facilities may include the clients 144A-D shown in FIG. 1 and vice versa.

The threat management facility 100 may include computers, software, or other computing facilities supporting a plurality of functions, such as security management facility 122, policy management facility 112, update facility 120, a definitions facility 114, network access rules facility 124, remedial action facility 128, detection techniques facility 130, testing facility 118, a threat research facility 132, and the like. In embodiments, the threat protection provided by the threat management facility 100 may extend beyond the network boundaries of the network 102 to include clients 144D (or client facilities) that have moved into network connectivity not directly associated with or controlled by the network 102. Threats to client facilities may come from a variety of sources, such as from network threats 104, physical proximity threats 110, secondary location threats 108, and the like. Clients 144A-D may be protected from threats even when the client 144A-D is not directly connected or in association with the network 102, such as when a client 144E-F moves in and out of the network 102, for example when interfacing with an unprotected server 142C through the Internet 154, when a client 144F is moving into a secondary location threat 108 network such as interfacing with components 140B, 142B, 148C, 148D that are not protected, and the like.

The threat management facility 100 may use or may be included in an integrated system approach to provide network 102 protection from a plurality of threats to device resources in a plurality of locations and network configurations. The threat management facility 100 may also or instead be deployed as a stand-alone solution. For example, some or all of the threat management facility 100 components may be integrated into a server or servers at a remote location, for example in a cloud computing facility. For example, some or all of the threat management facility 100 components may be integrated into a firewall, gateway, or access point within or at the border of the network 102. In some embodiments, the threat management facility 100 may be integrated into a product, such as a third-party product, e.g., through an application programming interface, which may be deployed on endpoints, on remote servers, on internal servers or gateways for a network, or some combination of these.

The security management facility 122 may include a plurality of elements that provide protection from malware to network 102 device resources in a variety of ways including endpoint security and control, email security and control, web security and control, reputation-based filtering, control of unauthorized users, control of guest and non-compliant computers, and the like. The security management facility 122 may include a local software application that provides protection to one or more network 10 devices. The security management facility 122 may have the ability to scan client facility files for malicious code, remove or quarantine certain applications and files, prevent certain actions, perform remedial actions and perform other security measures. This may include scanning some or all of the files stored on the client facility or accessed by the client facility on a periodic basis, scanning an application when the application is executed, scanning data (e.g., files or other communication) in transit to or from a device, etc. The scanning of applications and files may be performed to detect known or unknown malicious code or unwanted applications.

The security management facility 122 may provide email security and control. The security management facility 122 may also or instead provide for web security and control, such as by helping to detect or block viruses, spyware, malware, unwanted applications, and the like, or by helping to control web browsing activity originating from client devices. In an embodiment, the security management facility 122 may provide for network access control, which may provide control over network connections. In addition, network access control may control access to virtual private networks (VPN) that provide communications networks tunneled through other networks. The security management facility 122 may provide host intrusion prevention through behavioral based protection, which may guard against known or unknown threats by analyzing behavior before or while code executes. The security management facility 122 may provide reputation filtering, which may target or identify sources of code.

In general, the security management facility 122 may support overall security of the network 102 using the various techniques described above, optionally as supplemented by updates of malicious code information and so forth for distribution across the network 102.

The administration facility 134 may provide control over the security management facility 122 when updates are performed. Information from the security management facility 122 may also be sent from the enterprise back to a third party, a vendor, or the like, which may lead to improved performance of the threat management facility 100.

The threat management facility 100 may include a policy management facility 112 configured to take actions, such as to block applications, users, communications, devices, and so on based on determinations made. The policy management facility 112 may employ a set of rules or policies that determine network 102 access permissions for a client 144. In an embodiment, a policy database may include a block list, a blacklist, an allowed list, a white list, or the like, or combinations of the foregoing, that may provide a list of resources internal or external to the network 102 that may or may not be accessed by client devices 144. The policy management facility 112 may also or instead include rule-based filtering of access requests or resource requests, or other suitable techniques for controlling access to resources consistent with a corresponding policy.

The policy management facility 112 may also provide configuration policies to be used to compare and control the configuration of applications, operating systems, hardware, devices, network associated with the network 102. An evolving threat environment may dictate timely updates, and thus an update management facility 120 may also be provided by the threat management facility 100. In addition, a policy management facility 112 may require update management (e.g., as provided by the update facility 120 herein described). In embodiments, the update management facility 120 may provide for patch management or other software updating, version control, and so forth.

The security facility 122 and policy management facility 112 may push information to the network 102 and/or a given client 144. The network 102 and/or client 144 may also or instead request information from the security facility 122 and/or policy management facility 112, network server facilities 142, or there may be a combination of pushing and pulling of information. In an embodiment, the policy management facility 112 and the security facility 122 management update modules may work in concert to provide information to the network 102 and/or client 144 facility for control of applications, devices, users, and so on.

As threats are identified and characterized, the threat management facility 100 may create updates that may be used to allow the threat management facility 100 to detect and remediate malicious software, unwanted applications, configuration and policy changes, and the like. The threat definition facility 114 may contain threat identification updates, also referred to as definition files. A definition file may be a virus identity file that may include definitions of known or potential malicious code. The virus identity definition files may provide information that may identify malicious code within files, applications, or the like. The definition files may be accessed by security management facility 122 when scanning files or applications within the client facility for the determination of malicious code that may be within the file or application. A definition management facility may include a definition for a neural network or other recognition engine. A definition management facility 114 may provide timely updates of definition files information to the network, client facilities, and the like.

The security management facility 122 may be used to scan an outgoing file and verify that the outgoing file is permitted to be transmitted per the enterprise facility 102 rules and policies. By checking outgoing files, the security management facility 122 may be able to discover malicious code infected files that were not detected as incoming files.

The threat management facility 100 may provide controlled access to the network 102. A network access rules facility 124 may be responsible for determining if a client facility 144 application should be granted access to a requested network resource. In an embodiment, the network access rules facility 124 may verify access rights for client facilities 144 to or from the network 102 or may verify access rights of computer facilities to or from external networks. When network access for a client facility is denied, the network access rules facility 124 may send an information file to the client facility, e.g., a command or command file that the remedial action facility 128 may access and take action upon. The network access rules facility 124 may include one or more databases that may include a block list, a blacklist, an allowed list, a white list, a reputation list, an unacceptable network resource database, an acceptable network resource database, a network resource reputation database, or the like. The network access rules facility 124 may incorporate rule evaluation. Rule evaluation may, for example, parse network access requests and apply the parsed information to network access rules. The network access rule facility 124 may also or instead provide updated rules and policies to the enterprise facility 102.

When a threat or policy violation is detected by the threat management facility 100, the threat management facility 100 may perform or initiate remedial action through a remedial action facility 128. Remedial action may take a variety of forms, such as terminating or modifying an ongoing process or interaction, issuing an alert, sending a warning to a client or administration facility 134 of an ongoing process or interaction, executing a program or application to remediate against a threat or violation, record interactions for subsequent evaluation, and so forth. The remedial action may include one or more of blocking some or all requests to a network location or resource, performing a malicious code scan on a device or application, performing a malicious code scan on the client facility 144, quarantining a related application (or files, processes or the like), terminating the application or device, isolating the application or device, moving a process or application code to a sandbox for evaluation, isolating the client facility 144 to a location or status within the network that restricts network access, blocking a network access port from a client facility 144, reporting the application to an administration facility 134, or the like, as well as any combination of the foregoing.

Remedial action may be provided as a result of a detection of a threat or violation. The detection techniques facility 130 may include tools for monitoring the network or managed devices within the network 102. The detection techniques facility 130 may provide functions such as monitoring activity and stored files on computing facilities. Detection techniques, such as scanning a computer's stored files, may provide the capability of checking files for stored threats, either in the active or passive state. Detection techniques such as streaming file management may be used to check files received at the network, a gateway facility, a client facility, and the like.

Verifying that the threat management facility 100 detects threats and violations to established policy, may require the ability to test the system, either at the system level or for a particular computing component. The testing facility 118 may allow the administration facility 134 to coordinate the testing of the security configurations of client facility computing facilities on a network. For example, the administration facility 134 may be able to send test files to a set of client facility computing facilities to test the ability of the client facility to determine acceptability of the test file. After the test file has been transmitted, a recording facility may record the actions taken by the client facility in reaction to the test file. The recording facility may aggregate the testing information from the client facility and report the testing information to the administration facility 134. The administration facility 134 may be able to determine the level of preparedness of the client facility 144 based on the reported information. Remedial action may be taken for any of the client facilities 144 as determined by the administration facility 134.

The threat management facility 100 may provide threat protection across the network 102 to devices such as clients 144, a server facility 142, an administration facility 134, a firewall 138, a gateway, one or more network devices (e.g., hubs and routers 148, a threat management or other appliance 140, any number of desktop or mobile users, and the like. As used herein the term endpoint may refer to any compute instance running on a device that can source data, receive data, evaluate data, buffer data, process data or the like (such as a user's desktop computer, laptop, IoT device, server, etc.). This may, for example, include any client devices as well as other network devices and the like within the network 102, such as a firewall or gateway (as a data evaluation endpoint computer system), a laptop (as a mobile endpoint computer), a tablet (as a hand-held endpoint computer), a mobile phone, or the like. The term endpoint may also or instead refer to any final or intermediate source or destination for data within a network 102. The endpoint computer security facility 152 may be an application locally loaded onto any corresponding computer platform or computer support component, either for local security functions or for management by the threat management facility 100 or other remote resource, or any combination of these.

The network 102 may include a plurality of client facility computing platforms on which the endpoint computer security facility 152 is installed. A client facility computing platform may be a computer system that is able to access a service on another computer, such as a server facility 142, via a network. The endpoint computer security facility 152 may, in corresponding fashion, provide security in any suitable context such as among a plurality of networked applications, for a client facility connecting to an application server facility 142, for a web browser client facility connecting to a web server facility 142, for an e-mail client facility retrieving e-mail from an Internet 154 service provider's mail storage servers 142 or web site, and the like, as well as any variations or combinations of the foregoing.

The network 102 may include one or more of a variety of server facilities 142, such as application servers, communications servers, file servers, database servers, proxy servers, mail servers, fax servers, game servers, web servers, and the like. A server facility 142, which may also be referred to as a server facility 142 application, server facility 142 operating system, server facility 142 computer, or the like, may be any device(s), application program(s), operating system(s), or combination of the foregoing that accepts client facility connections in order to service requests from clients 144. In embodiments, the threat management facility 100 may provide threat protection to server facilities 142 within the network 102 as load conditions and application changes are made.

A server facility 142 may include an appliance facility 140, where the appliance facility 140 provides specific services to other devices on the network. Simple server facility 142 appliances may also be utilized across the network 102 infrastructure, such as switches, routers, hubs, gateways, print servers, modems, and the like. These appliances may provide interconnection services within the network 102, and therefore may advance the spread of a threat if not properly protected.

A client facility 144 may be protected from threats from within the network 102 using a local or personal firewall, which may be a hardware firewall, software firewall, or combination, that controls network traffic to and from a client. The local firewall may permit or deny communications based on a security policy. Another component that may be protected by an endpoint computer security facility 152 is a network firewall facility 138, which may include hardware or software, in a standalone device or integrated with another network component, that may be configured to permit, deny, or proxy data through a network 102.

The interface between the threat management facility 100 and the network 102, and through the appliance facility 140 to embedded endpoint computer security facilities, may include a set of tools that may be the same or different for various implementations, and may allow each network administrator to implement custom controls. In embodiments, these controls may include both automatic actions and managed actions. The administration facility 134 may configure policy rules that determine interactions. The administration facility 134 may also establish license management, which in turn may further determine interactions associated with licensed applications. In embodiments, interactions between the threat management facility 100 and the network 102 may provide threat protection to the network 102 by managing the flow of network data into and out of the network 102 through automatic actions that may be configured by the threat management facility 100 for example by action or configuration of the administration facility 134.

Client facilities 144 within the network 102 may be connected to the network 102 by way of wired network facilities 148A or wireless network facilities 148B. Mobile wireless facility clients 144, because of their ability to connect to a wireless network access point, may connect to the Internet 154 outside the physical boundary of the network 102, and therefore outside the threat-protected environment of the network 102. Such a client 144, if not for the presence of a locally installed endpoint computer security facility 152, may be exposed to a malware attack or perform actions counter to network 102 policies. Thus, the endpoint computer security facility 152 may provide local protection against various threats and policy violations. The threat management facility 100 may also or instead be configured to protect the out-of-enterprise facility 102 mobile client facility (e.g., the clients 144) through interactions over the Internet 154 (or other network) with the locally installed endpoint computer security facility 152. Thus, mobile client facilities that are components of the network 102 but temporarily outside connectivity with the network 102 may be provided with the threat protection and policy control the same as or similar to client facilities 144 inside the network 102. In addition, mobile client facilities 144 may receive the same interactions to and from the threat management facility 100 as client facilities 144 inside the enterprise facility 102, such as by receiving the same or equivalent services via an embedded endpoint computer security facility 152.

Interactions between the threat management facility 100 and the components of the network 102, including mobile client facility extensions of the network 102, may ultimately be connected through the Internet 154 or any other network or combination of networks. Security-related or policy-related downloads and upgrades to the network 102 may be passed from the threat management facility 100 through to components of the network 102 equipped with the endpoint computer security facility 152. In turn, the endpoint computer security facility 152 components of the enterprise facility or network 102 may upload policy and access requests back across the Internet 154 and through to the threat management facility 100. The Internet 154 however, is also the path through which threats may be transmitted from their source, and an endpoint computer security facility 152 may be configured to protect a device outside the network 102 through locally deployed protective measures and through suitable interactions with the threat management facility 100.

Thus, if the mobile client facility were to attempt to connect into an unprotected connection point, such as at a secondary location 108 that is not a part of the network 102, the mobile client facility 144 may be required to request network interactions through the threat management facility 100, where contacting the threat management facility 100 may be performed prior to any other network action. In embodiments, the client facility's 144 endpoint computer security facility 152 may manage actions in unprotected network environments such as when the client facility (e.g., client 144F) is in a secondary location 108, where the endpoint computer security facility 152 may dictate what applications, actions, resources, users, etc. are allowed, blocked, modified, or the like.

The secondary location 108 may have no endpoint computer security facilities 152 as a part of its components, such as its firewalls 138B, servers 142B, clients 144G, hubs and routers 148C-D, and the like. As a result, the components of the secondary location 108 may be open to threat attacks, and become potential sources of threats, as well as any mobile enterprise facility clients 144B-F that may be connected to the secondary location's 108 network. In this instance, these components may now unknowingly spread a threat to others connected to the network 102.

Some threats do not come directly from the Internet 154. For example, a physical proximity threat 110 may be deployed on a client device while that device is connected to an unprotected network connection outside the enterprise facility 102, and when the device is subsequently connected to a client 144 on the network 102, the device can deploy the malware or otherwise pose a threat. In embodiments, the endpoint computer security facility 152 may protect the network 102 against these types of physical proximity threats 110, for instance, through scanning any device prior to allowing data transfers, through security validation certificates, through establishing a safe zone within the network 102 to receive data for evaluation, and the like.

Having provided an overall context for threat detection, the description now turns to a brief discussion of embodiments of the present concept, followed by a description of systems and methods for detecting malicious enumeration attacks.

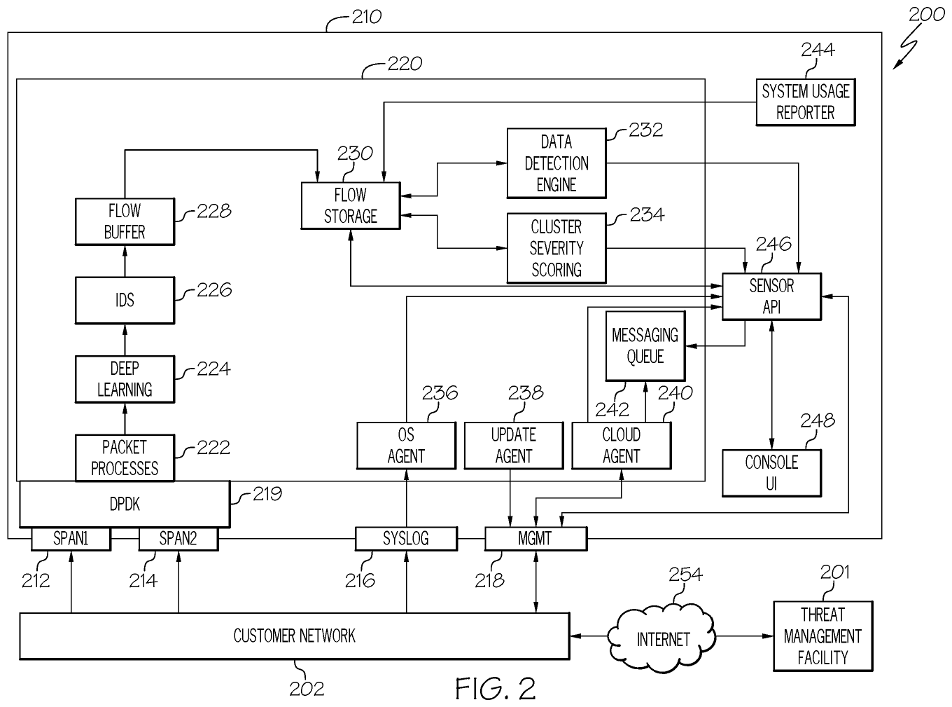

FIG. 2 depicts an architectural representation of a network detection and response computer system 200, according to an example embodiment. The network detection and response computer system 200 may be any NDR computer system with standard capabilities of an NDR system. In addition, the NDR computer system includes a data detection engine 232 which may provide the capabilities of automatically detecting malicious enumeration attempts, as described herein. Thus, the network detection and response computer system 200 may depict a representation of an example NDR computer system in which the methods and systems described herein may be deployed, but embodiments are not limited to the specific NDR computer system depicted in FIG. 2.

The network detection and response computer system 200 includes a network detection and response sensor virtual machine 210, which may also be a physical computer system in other embodiments. The network detection and response sensor virtual machine 210 is shown connected to a customer network 202, which may be connected to a threat management facility 201 via the internet 254. In the network detection and response computer system 200, it is contemplated that the network detection and response sensor virtual machine 210 is an agent deployed for the customer network 202 that is separate from the threat management facility 201 central monitoring hub. In other embodiments, the network detection and response sensor virtual machine 210 may be a component of the threat management facility and may be monitoring the customer network 202 remotely therefrom. Whatever the embodiment, the customer network 202 may be configured to provide flow data associated with web traffic to the network detection and response sensor virtual machine 210 for processing.

The network detection and response computer system 200 receives information from the customer network 202 to various information channels, including a data plane development kit (DPDK) 219 which includes grid columns SPAN1 212 and SPAN2 214.

Data received by the DPDK 219 may be provided to a Kubernetes instance 220. While the present embodiment contemplates a Kubernetes instance, other containerized environments may be deployed instead of Kubernetes. Within the Kubernetes instance 220, data may be processed by a packet processor 223, a deep learning algorithm 224, an intrusion detection system 226 and a flow buffer 228 being stored and/or processing by a database management system flow storage 230. The database management system flow storage 230 may be, for example, a ClickHouse® database management flow storage system, or the like, and may be in communication with the data detection engine 232 and a cluster severity scoring module 234, as well as a system usage reporter 244. The data detection engine 232 may include the code and algorithms for performing the various methodologies described herein. The data detection engine 232, the cluster severity scoring module 234 and the database management system flow storage 230 may further be in communication with a sensor API module 246. The sensor API module 246 may provide API support for the console UI 248, which may be accessible by an administrator.

The customer network 202 may further be in communication with a system log 216 channel which provides information to an operating system agent 236, such as a SOC.OS agent, which may be configured to forward system log alerts to the sensor API module 246.

Furthermore, the customer network 202 may provide information to a management interface 218 dedicated to configuration management operations. The management interface 218 may be in communication with an update agent 238 within the Kubernetes instances 220. The management interface 218 may be in communication with a cloud agent 240 which communicates with the sensor API module 246. The management interface 218 may also communicate directly with the sensor API module 246. The cloud agent 240 may have a message queue 242 which may facilitate work distribution. The message queue 242 may further be in communication with the sensor API module 246.

While a single Kubernetes instance 220 is shown in the embodiment depicted, embodiments contemplate incorporating any number of the Kubernetes instances 220 within the network detection and response computer system 200, depending on workload demands. Thus, present systems may be deployed as a Kubernetes cluster managed by an instance-manager, should the creation of additional worker nodes be required.

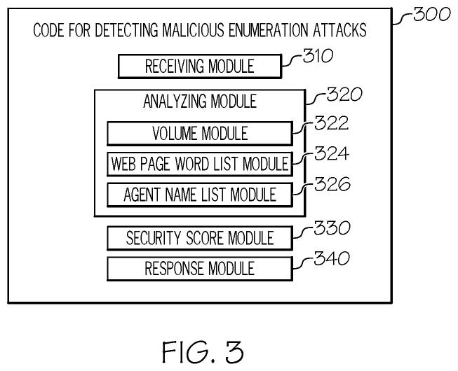

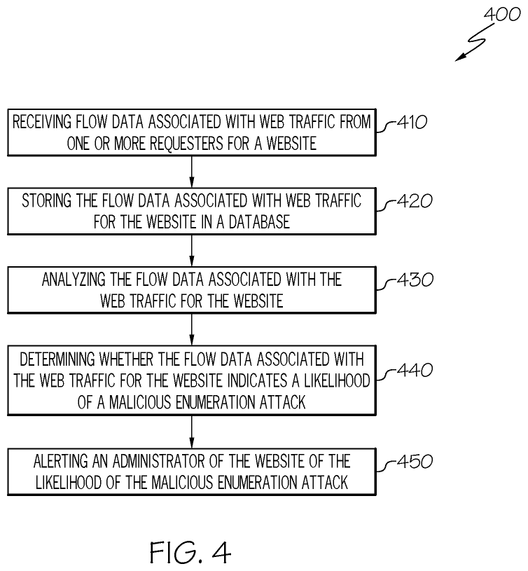

FIG. 3 depicts a diagram of modules included in computer code contained within the systems of FIGS. 1 and 2, according to an example embodiment. In particular, the computer code may be contained within the Kubernetes instance 220 described hereinabove. More particularly, the data detection engine 232 within the Kuberenetes instances 220 of the network detection and response computer system 200 may include the code for the various processing, analyzing, and responding steps, for example. The code for detecting malicious enumeration attacks 300 includes a receiving module 310, an analyzing module 320, a security score module 330, and a response module 340. Furthermore, the analyzing module 320 includes a plurality of sub-modules including a volume module 322, a web page word list module 324, and an agent name list module 324. The number of modules can vary, and some modules may be combined with other modules or separated into two or more modules in various combinations. The functionality of the modules included in code for detecting malicious enumeration attacks 300 is discussed in detail with respect to the methodology shown in FIGS. 4-6, which is presented below.

FIG. 4 depicts a method 400 for detecting malicious enumeration attacks, according to an example embodiment. The method 400 includes various steps which may be performable by the network detection and response computer system 200, and more particularly by the data detection engine 232 thereof.

The method 400 includes a first step 410 of receiving flow data associated with web traffic from one or more requesters for a website. For example, receiving flow data may be performable by the receiving module 310, described herein above, and may be conducted by the data detection engine 232 receiving information from the database management system flow storage 230. Conceptually, the first step 410 may also be performable by the DPDK 219 receiving information from the customer network 202, or the database management system flow storage 230 receiving flow related data from the DPDK 219. Whatever the embodiment, methods herein contemplate receiving flow related data associated with web traffic from one or more requesters for a website.

The method 400 then includes a step 420 of storing the flow data associated with web traffic for the website in a database. Again, the step 420 may be conducted by the receiving module 310 described herein above, and may be further performed by the database management system flow storage 230 of the Kubernetes instance 220.

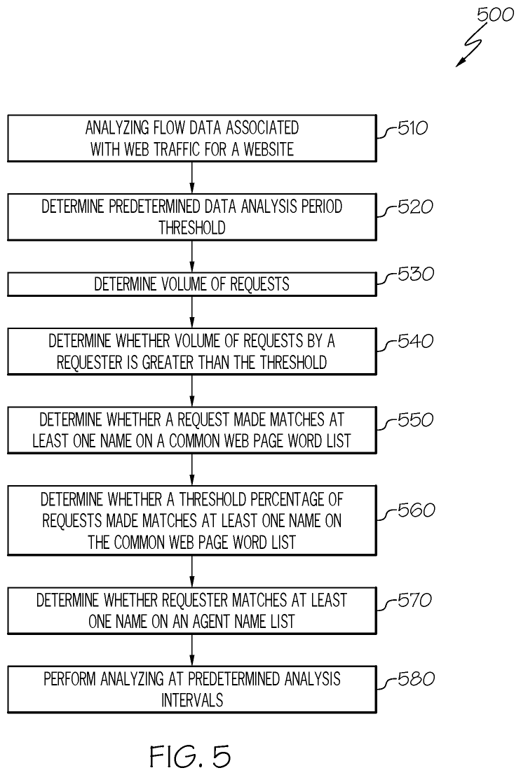

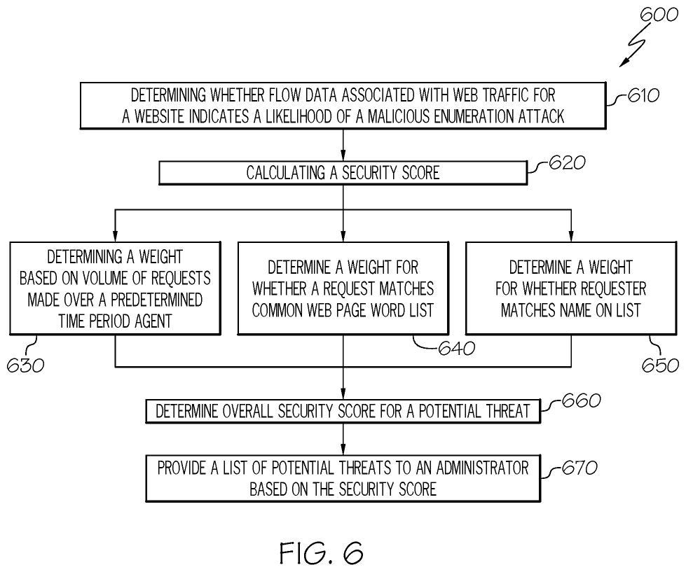

The method 400 then includes a step 430 of analyzing the flow data associated with the web traffic for the website that has been received and/or stored in steps 410, 420. The analyzing may be performable with the analyzing module 320 and is more particularly detailed herein below with respect to FIGS. 5 and 6. The analyzing may be accomplished by analyzing the flow related information which may be available and seen by the system without deep packet inspection or decryption.

Next, the method 400 includes a step 440 of determining whether the flow data associated with the web traffic for the website indicates a likelihood of a malicious enumeration attack. The step 440 may be based on the analysis conducted in step 430, and may further incorporate determining a security score based on the analysis conducted. The step 440 may be performable by the security score module 330, for example, or any other determination module for making a determination based on the analysis conducted. While labeling certain web traffic with a security score is contemplated in one example, various other means of determining whether web traffic is malicious or likely a enumeration attack are contemplated which are based on the specific analysis made in step 430 and described herein below.

The method 400 may then include a final step 450 of alerting an administrator of the website of the likelihood of a malicious enumeration attack. The step 450 may be conducted by the response module 340 described herein above. While the method 400 depicts one example of a response, other examples are contemplated. For example, sending an automated alert to a threat management facility, such as the threat management facility 100, 201 is contemplated. Moreover, making an automatic adjustment to a network setting based on the determination of the likelihood of a malicious enumeration attack is also contemplated. Still further, responses may include providing information or alerts to other networks, or other devices within the customer network 202.

FIG. 5 depicts a method 500 for analyzing flow data associated with web traffic for a website, according to an example embodiment. While the method 500 includes various steps, embodiments contemplated herein may include one, a portion, or all of the steps included. Embodiments are not limited to the specific steps of the analysis described herein. The method 500 may be performable by the analyzing module 320 described hereinabove. Thus, the method 500 includes various steps which may be performable by the network detection and response computer system 200, and more particularly by the data detection engine 232 thereof.

The method 500 is shown including an initial step of analyzing the flow data associated with the web traffic for the website 510. This step 510 may include any or all of the following steps.

The method 500 is shown including a step 520 of determining a predetermined data analysis period threshold 520, and a step 530 of determining a volume of requests, followed by a step 540 of determining whether a volume of requests by a specific requester is greater than a threshold over the predetermined analysis period determined in step 520. Thus, as contemplated herein, two toggles or dials may be fine-tuned-a threshold for a volume of request, and a given time period. The longer the time period and the lower of the volume of requests by a specific requester, the more sensitive the analysis may be. In contrast, the shorter the time period, and the higher the volume of requests by a specific requester, the less likely the system may be configured to note a potential attack. It should be understood that MAC address and/or IP address information may be utilized in the step 540 of determining whether the volume of requests by a requester is greater than a threshold over a given period of time. This determination may provide a first level of confidence in a malicious enumeration attack. However, the method 500 contemplates using other determinations in order to gain further potential confidence of a malicious attack. The method steps 520, 530, 540 may be conducted by the volume sub module 322 of the analyzing module 320.

For example, the method 500 then includes a next step 550 of determining whether a request made matches at least one name on a common web page word list. If so, the method 500 then includes a step 560 of determining whether a threshold percentage of requests made matches at least one name on the common web page word list. If one or more requests by a requester match a known list of common web pages, this may indicate the likelihood of a malicious enumeration attack. The method steps 550, 560 may be conducted by the web page word list sub module 324 of the analyzing module 320.

Various word lists are known which contain common web page names and are used by enumeration attacks. Thus, the present embodiments contemplate analyzing the wording in requests made to match a list of common web pages. While the list of common web pages may be a public list, in other embodiments it is contemplated to generate a specific finely tuned list for the purposes of implementing the methods described herein. Again, matching requests to a known word list may provide further confidence of a malicious enumeration attack.

In some embodiments, the threshold percentage may be 50 percent. However, the threshold percentage may also be an adjusted percentage. The lower the percentage, the more sensitive the analysis of the flow data may be. In some embodiments a 75% match for requests made by a requester to a word list may indicate a high likelihood of a malicious enumeration attack. The web page word list contemplated may have any number of the most common web page names. For example, a word list may be a list which includes 1000 separate web page names. In other embodiments, the word list may include more or less entries.

Still further, the method 500 includes a step 570 of determining whether a requester matches at least one name on an agent name list. There are known agents which are known to perform enumeration attacks. For example, a “crawler” user agent may be known to be deployed during enumeration attacks. Not all “crawler” requests may be indicative of an enumeration attack, but it may be highly likely that an enumeration attack may use a “crawler” user agent. Thus, reviewing the agent list and matching with known enumeration agent names may provide additional confidence. The method step 570 may be conducted by the agent name list sub module 340 of the analyzing module 320.

While the above method 500 includes an analysis of three separate indications of a potential malicious enumeration attack, methods contemplate using one or any combination of these indications, or even bolstering the confidence provided by these indications by additional potential indications not described. Whatever the embodiment, the method 500 may include a step 580 of performing the analysis of flow related data at regular predetermined analysis intervals. While the method 500 contemplates running an analysis of these various indicators at regular predetermined intervals, it is also contemplated to deploy the analysis in real time as data is received.

FIG. 6 depicts a method 600 for calculating a security score, according to an example embodiment. The security score calculated may then be utilized to determine whether a malicious enumeration attack has occurred. The security score calculation provides a framework for understanding the various indications analyzed in the method 500. However, other means of calculating a security score are contemplated than the specific method 600 described herein. Thus, the method 600 includes various steps which may be performable by the network detection and response computer system 200, and more particularly by the data detection engine 232 thereof.

The method 600 is shown including an initial step 610 of determining whether the flow data associated with the web traffic for the website indicates a likelihood of a malicious enumeration attack. This step 610 may include any or all of the following steps.

The method 600 then includes a step of beginning calculating a security score 620. The method 600 then branches into three separate calculations, based on the three indications output by the method 500. In a first step 630, the method 600 includes determining a weight score based on a volume of requests made over a predetermined period by a given agent. In one embodiment, the step 630 includes assigning a value if the volume of requests made over a predetermined period by a given agent exceeds a certain threshold. In another example, it may be that a larger value is assigned based on the specific volume of requests over a predetermined time period. For example, the assigned weight value may be larger if the number of requests is larger.

The method 600 then includes a step 640 of determining a weight for whether a request matches a common web page word list. For example, the step 640 may include assigning a weight value if the percentage of requests which matches a web page word list exceeds a percentage threshold. In another embodiment, the weight value may increase as the overlap between requests and the web page word list increases.

Finally, the method 600 includes a step 650 of determining a weight for whether a requester matches the name on a requester list. It may be that this weight may be a simple additional value based on whether a match exists. However, it may also be that certain names on the agent list may increase the weight value more than other names on the agent list. For example, if a first agent is more likely to be indicative of an enumeration attack than a second agent (even if the second agent may be possibly indicative of an enumeration attack), it is possible to weigh the first agent with a higher score than the second agent.

With the overall weights or scores thereby provided from the three indications, the method 600 then includes a step 660 of determining an overall security score associated with a given threat. A given threat may encompass all the requests made by a given single requester over a certain time period. If the overall security score associated with a given threat exceeds a threshold value, the threat may be added to a list of threats which may be provided to an administrator or otherwise responded to. The method 600 includes the final step 670 of providing one or more potential threats to an administrator system based on the determined security score. The final step 670 may be, for example, conducted, each time the analysis is conducted at predetermined intervals in step 580 of the method 500, should any potential threats be identified. The final step 670 may be accomplished by the response module 340, for example. The final step 670 may be providing an indication of a threat, along with information associated with the threat (i.e., IP address, requests made, etc.). Additionally, the indication of the threat provided in the final step 670 may include an indication of the likelihood of the threat based on the calculated security score. For example, the step 670 may include characterizing a threat level (e.g., “high” or “moderate”) based on the score level. A higher score level may include characterizing a threat with a higher rating by the alert.

While an alert is contemplated by the method 600, other responses may also be contemplated, such as automatically taking an action based on a threat. Alternatively, the response may include providing an administrator with an option to approve an automated response, which would thereby initiate should the administrator provide a one-response (i.e., a one-click) approval. The type of response may also be configured to differ based on the determined potential threat level. For example, a higher security score for a potential threat may result in a higher degree of an automated action-taking response, whereby a lower security score for a potential threat (which is still high enough to indicate a likely threat) may provide an administrator alert. Various response possibilities are contemplated.

It is contemplated that the systems described herein may collect and respond to threats both internal and external to a given customer network being monitored. Based on the flow related data collected and analyzed, the described methods contemplate determining whether a threat is internal or external. Furthermore, the described methods contemplate determining whether the target is a managed device on a customer network.

It is further contemplated that any of the methods contemplated herein may require permissions to be granted by a customer, customer network, administrator(s) and/or user(s) thereof, or the like.

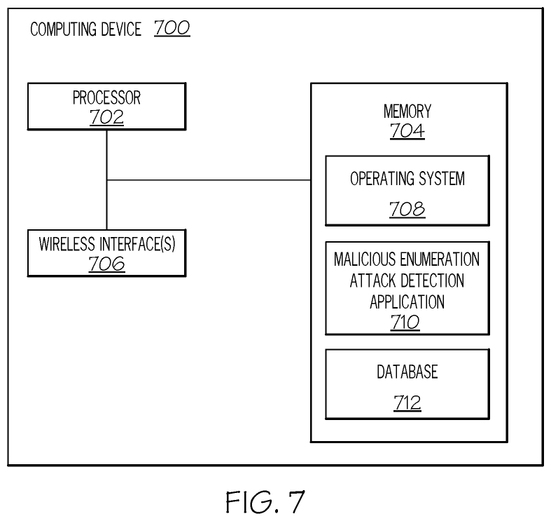

FIG. 7 is a diagram of an example computing device 700, according to an example embodiment. As shown, the computing device 700 includes one or more processors 702, non-transitory computer readable medium or memory 704, I/O interface devices 706 (e.g., wireless communications, etc.) and a network interface 708. The computer readable medium 704 may include an operating system 708, a malicious enumeration attack detection application 710 for detecting malicious enumeration attacks using flow data in accordance with the systems and methods described herein.

In operation, the processor 702 may execute the application 710 stored in the computer readable medium 704. The application 710 may include software instructions that, when executed by the processor, cause the processor to perform operations for detecting malicious enumeration attacks, as described and shown in FIGS. 2-7, with particular reference to the steps of the methodology shown in FIGS. 4-7.

The application program 710 may operate in conjunction with the data section 712 and the operating system 708. The device 700 may communicate with other devices (e.g., a wireless access point) via the I/O interfaces 706.

Although the foregoing Figures illustrate various embodiments of the disclosed systems and methods, additional and/or alternative embodiments are contemplated as falling within the scope of this disclosure. For example, in one embodiment, this disclosure provides for a method that includes receiving, by one or more processors of a network detection and response computer system, flow data associated with web traffic from one or more requesters for a website, analyzing, by the one or more processors of the network detection and response computer system, the flow data associated with the web traffic for the website, determining, by the one or more processors of the network detection and response computer system, whether the flow data associated with the web traffic for the website indicates a likelihood of a malicious enumeration attack, and alerting, by the one or more processors of the network detection and response computer system, an administrator of the website of the likelihood of the malicious enumeration attack.

In another embodiment of the method, the receiving the flow data associated with web traffic for the website further includes storing, by the one or more processors of the network detection and response computer system, the flow data associated with web traffic for the website in a database, wherein the database is configured to maintain the flow data for a predetermined data retention period.

In a further embodiment of the method, the analyzing the flow data associated with the web traffic for the website further includes determining, by the one or more processors of the network detection and response computer system, that a potential threat exists when a volume of requests by a requester of the one or more requesters over a predetermined data analysis period is greater than a threshold.

In yet another embodiment of the method, the analyzing the flow data associated with the web traffic for the website further includes determining, by the one or more processors of the network detection and response computer system, whether a request made by the requester matches at least one name on a word list of common web pages.

In yet a further embodiment of the method, the analyzing the flow data associated with the web traffic for the website further includes determining, by the one or more processors of the network detection and response computer system, whether a threshold percentage of the requests made by the requester matches at least one name on the word list of common web pages.

In another embodiment of the method, the analyzing the flow data associated with the web traffic for the website further includes determining, by the one or more processors of the network detection and response computer system, whether the requester matches at least one name on an agent name list.

In a further embodiment of the method, the analyzing the flow data associated with the web traffic for the website further includes determining, by the one or more processors of the network detection and response computer system, whether the requester matches at least one name on an agent name list.

In yet another embodiment of the method, the analyzing is performed at predetermined analysis intervals, wherein at each predetermined analysis interval a list of each determined potential threat is provided with a calculated security score for each of the potential threats.

In yet a further embodiment of the method, the volume of requests by a requester of the one or more requesters is adjustable, and wherein the predetermined data analysis period is adjustable by an administrator of the network detection and response computer system.

In another embodiment of the method, the one or more processors of the network detection and response computer system does not perform packet analysis in determining whether the flow data associated with the web traffic for the website indicates the likelihood of the malicious enumeration attack.

In another embodiment, the disclosure provides for a computer system that includes one or more computer processors, one or more computer readable storage media, and computer readable code stored collectively in the one or more computer readable storage media, with the computer readable code including data and instructions to cause the one or more computer processors to perform a method that includes receiving, by the one or more processors, flow data associated with web traffic from one or more requesters for a website, analyzing, by the one or more processors, the flow data associated with the web traffic for the website, determining, by the one or more processors, whether the flow data associated with the web traffic for the website indicates a likelihood of a malicious enumeration attack, and alerting, by the one or more processors, an administrator of the website of the likelihood of the malicious enumeration attack.

In another embodiment of the computer system, the receiving the flow data associated with web traffic for the website further includes storing, by the one or more processors of the network detection and response computer system, the flow data associated with web traffic for the website in a database, wherein the database is configured to maintain the flow data for a predetermined data retention period.

In a further embodiment of the computer system, the analyzing the flow data associated with the web traffic for the website further includes determining, by the one or more processors of the network detection and response computer system, that a potential threat exists when a volume of requests by a requester of the one or more requesters over a predetermined data analysis period is greater than a threshold.

In yet another embodiment of the computer system, the analyzing the flow data associated with the web traffic for the website further includes determining, by the one or more processors of the network detection and response computer system, whether a request made by the requester matches at least one name on a word list of common web pages.

In yet a further embodiment of the computer system, the analyzing the flow data associated with the web traffic for the website further includes determining, by the one or more processors of the network detection and response computer system, whether a threshold percentage of the requests made by the requester matches at least one name on the word list of common web pages.

In another embodiment of the computer system, the analyzing the flow data associated with the web traffic for the website further includes determining, by the one or more processors of the network detection and response computer system, whether the requester matches at least one name on an agent name list.

In a further embodiment of the computer system, the analyzing the flow data associated with the web traffic for the website further includes determining, by the one or more processors of the network detection and response computer system, whether the requester matches at least one name on an agent name list.

In yet another embodiment of the computer system, the analyzing is performed at predetermined analysis intervals, wherein at each predetermined analysis interval a list of each determined potential threat is provided with a calculated security score for each of the potential threats.

In yet a further embodiment of the computer system, the volume of requests by a requester of the one or more requesters is adjustable, and wherein the predetermined data analysis period is adjustable by an administrator of the network detection and response computer system.

In another embodiment of the computer system, the one or more processors of the network detection and response computer system does not perform packet analysis in determining whether the flow data associated with the web traffic for the website indicates the likelihood of the malicious enumeration attack.

In another embodiment, the disclosure provides for a computer program product that includes one or more computer readable storage media having computer readable program code collectively stored on the one or more computer readable storage media, the computer readable program code being executed by one or more processors of a network detection and response computer system to cause the computer system to perform a method. The method includes receiving, by one or more processors of a network detection and response computer system, flow data associated with web traffic from one or more requesters for a website, analyzing, by the one or more processors of the network detection and response computer system, the flow data associated with the web traffic for the website, determining, by the one or more processors of the network detection and response computer system, whether the flow data associated with the web traffic for the website indicates a likelihood of a malicious enumeration attack, and alerting, by the one or more processors of the network detection and response computer system, an administrator of the website of the likelihood of the malicious enumeration attack.

In another embodiment of the computer system, the receiving the flow data associated with web traffic for the website further includes storing, by the one or more processors of the network detection and response computer system, the flow data associated with web traffic for the website in a database, wherein the database is configured to maintain the flow data for a predetermined data retention period.

In a further embodiment of the computer system, the analyzing the flow data associated with the web traffic for the website further includes determining, by the one or more processors of the network detection and response computer system, that a potential threat exists when a volume of requests by a requester of the one or more requesters over a predetermined data analysis period is greater than a threshold.

In yet another embodiment of the computer system, the analyzing the flow data associated with the web traffic for the website further includes determining, by the one or more processors of the network detection and response computer system, whether a request made by the requester matches at least one name on a word list of common web pages.

In yet a further embodiment of the computer system, the analyzing the flow data associated with the web traffic for the website further includes determining, by the one or more processors of the network detection and response computer system, whether a threshold percentage of the requests made by the requester matches at least one name on the word list of common web pages.

In another embodiment of the computer system, the analyzing the flow data associated with the web traffic for the website further includes determining, by the one or more processors of the network detection and response computer system, whether the requester matches at least one name on an agent name list.

In a further embodiment of the computer system, the analyzing the flow data associated with the web traffic for the website further includes determining, by the one or more processors of the network detection and response computer system, whether the requester matches at least one name on an agent name list.

In yet another embodiment of the computer system, the analyzing is performed at predetermined analysis intervals, wherein at each predetermined analysis interval a list of each determined potential threat is provided with a calculated security score for each of the potential threats.

In yet a further embodiment of the computer system, the volume of requests by a requester of the one or more requesters is adjustable, and wherein the predetermined data analysis period is adjustable by an administrator of the network detection and response computer system.

In another embodiment of the computer system, the one or more processors of the network detection and response computer system does not perform packet analysis in determining whether the flow data associated with the web traffic for the website indicates the likelihood of the malicious enumeration attack.

It will be appreciated that the modules, processes, systems, and sections described above may be implemented in hardware, hardware programmed by software, software instructions stored on a nontransitory computer readable medium or a combination of the above. A system as described above, for example, may include a processor configured to execute a sequence of programmed instructions stored on a nontransitory computer readable medium. For example, the processor may include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions may be compiled from source code instructions provided in accordance with a programming language such as Java, C, C++, C#.net, assembly or the like. The instructions may also comprise code and data objects provided in accordance with, for example, the Visual Basic™ language, or another structured or object-oriented programming language. The sequence of programmed instructions, or programmable logic device configuration software, and data associated therewith may be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein may be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that may be used on a variety of computer platforms. Alternatively, embodiments of the disclosed method, system, and computer program product may be implemented partially or fully in hardware using, for example, standard logic circuits or a VLSI design. Other hardware or software may be used to implement embodiments depending on the speed and/or efficiency requirements of the systems, the particular function, and/or particular software or hardware system, microprocessor, or microcomputer being utilized. Embodiments of the method, system, and computer program product may be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) may be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for secure VLAN in wireless networks.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter. It should also be understood that references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

1. A method for detecting malicious enumeration attacks, comprising:
receiving, by one or more processors of a network detection and response computer system, flow data associated with web traffic from one or more requesters for a website;
analyzing, by the one or more processors of the network detection and response computer system, the flow data associated with the web traffic for the website;
determining, by the one or more processors of the network detection and response computer system, whether the flow data associated with the web traffic for the website indicates a likelihood of a malicious enumeration attack; and
alerting, by the one or more processors of the network detection and response computer system, an administrator of the website of the likelihood of the malicious enumeration attack.

2. The method of claim 1, wherein the receiving the flow data associated with web traffic for the website further comprises:
storing, by the one or more processors of the network detection and response computer system, the flow data associated with web traffic for the website in a database, wherein the database is configured to maintain the flow data for a predetermined data retention period.

3. The method of claim 1, wherein the analyzing the flow data associated with the web traffic for the website further comprises:
determining, by the one or more processors of the network detection and response computer system, that a potential threat exists when a volume of requests by a requester of the one or more requesters over a predetermined data analysis period is greater than a threshold.

4. The method of claim 3, wherein the analyzing the flow data associated with the web traffic for the website further comprises:
determining, by the one or more processors of the network detection and response computer system, whether a request made by the requester matches at least one name on a word list of common web pages.

5. The method of claim 4, wherein the analyzing the flow data associated with the web traffic for the website further comprises:
determining, by the one or more processors of the network detection and response computer system, whether a threshold percentage of the requests made by the requester matches at least one name on the word list of common web pages.

6. The method of claim 5, wherein the analyzing the flow data associated with the web traffic for the website further comprises:
determining, by the one or more processors of the network detection and response computer system, whether the requester matches at least one name on an agent name list.

7. The method of claim 6, wherein the determining whether the flow data associated with the web traffic for the website indicates the likelihood of the malicious enumeration attack further comprises:
calculating, by the one or more processors of the network detection and response computer system, a security score based on:
the volume of requests by the requester over the predetermined data analysis period;
whether the threshold percentage of the requests made by the requester matches a request on the word list of common web pages; and
whether the requester matches at least one name on an agent name list.

8. The method of claim 7, wherein the analyzing is performed at predetermined analysis intervals, wherein at each predetermined analysis interval a list of each determined potential threat is provided with a calculated security score for each of the potential threats.

9. The method of claim 3, wherein the volume of requests by a requester of the one or more requesters is adjustable, and wherein the predetermined data analysis period is adjustable by an administrator of the network detection and response computer system.

10. The method of claim 1, wherein the one or more processors of the network detection and response computer system does not perform packet analysis in determining whether the flow data associated with the web traffic for the website indicates the likelihood of the malicious enumeration attack.

11. A computer system, comprising:
one or more processors;
one or more computer readable storage media; and
computer readable code stored collectively in the one or more computer readable storage media, with the computer readable code including data and instructions to cause the one or more computer processors to perform a method comprising:
receiving, by the one or more processors, flow data associated with web traffic from one or more requesters for a website;
analyzing, by the one or more processors, the flow data associated with the web traffic for the website;
determining, by the one or more processors, whether the flow data associated with the web traffic for the website indicates a likelihood of a malicious enumeration attack; and
alerting, by the one or more processors, an administrator of the website of the likelihood of the malicious enumeration attack.

12. The computer system of claim 11, wherein the receiving the flow data associated with web traffic for the website further comprises:
storing, by the one or more processors, the flow data associated with web traffic for the website in a database, wherein the database is configured to maintain the flow data for a predetermined data retention period.

13. The computer system of claim 11, wherein the analyzing the flow data associated with the web traffic for the website further comprises:
determining, by the one or more processors, that a potential threat exists when a volume of requests by a requester of the one or more requesters over a predetermined data analysis period is greater than a threshold.

14. The computer system of claim 13, wherein the analyzing the flow data associated with the web traffic for the website further comprises:
determining, by the one or more processors, whether a request made by the requester matches at least one request on a word list of common web pages.

15. The computer system of claim 14, wherein the analyzing the flow data associated with the web traffic for the website further comprises:
determining, by the one or more processors, whether a threshold percentage of the requests made by the requester matches at least one request on the word list of common web pages.

16. The computer system of claim 15, wherein the analyzing the flow data associated with the web traffic for the website further comprises:
determining, by the one or more processors, whether the requester matches at least one name on an agent name list.

17. The computer system of claim 16, wherein the determining whether the flow data associated with the web traffic for the website indicates the likelihood of the malicious enumeration attack further comprises:
calculating, by the one or more processors, a security score based on:
the volume of requests by the requester over the predetermined data analysis period;
whether the threshold percentage of the requests made by the requester matches a request on the word list of common web pages; and
whether the requester matches at least one name on an agent name list.

18. The computer system of claim 17, wherein the analyzing is performed at predetermined analysis intervals, wherein at each predetermined analysis interval a list of each determined potential threat is provided with a calculated security score for each of the potential threats.

19. The computer system of claim 13, wherein the volume of requests by a requester of the one or more requesters is adjustable, and wherein the predetermined data analysis period is adjustable by an administrator of the network detection and response computer system.

20. The computer system of claim 11, wherein the one or more processors does not perform packet analysis in determining whether the flow data associated with the web traffic for the website indicates the likelihood of the malicious enumeration attack.

21. A computer program product comprising:
one or more computer readable storage media having computer readable program code collectively stored on the one or more computer readable storage media, the computer readable program code being executed by one or more processors of a network detection and response computer system to cause the computer system to perform a method comprising:
receiving, by one or more processors of a network detection and response computer system, flow data associated with web traffic from one or more requesters for a website;
analyzing, by the one or more processors of the network detection and response computer system, the flow data associated with the web traffic for the website;
determining, by the one or more processors of the network detection and response computer system, whether the flow data associated with the web traffic for the website indicates a likelihood of a malicious enumeration attack; and
alerting, by the one or more processors of the network detection and response computer system, an administrator of the website of the likelihood of the malicious enumeration attack.
